(19) United States
(12) Patent Application Publication
(10) Pub. No.: US 2004/0120875 A1
(43) Pub. Date: Jun. 24, 2004

(54) Desulfurization and novel sorbent for the same

(76) Inventors: Robert W. Morton, Bartlesville, OK (US); Jason J. Gislason, Bartlesville, OK (US); Glenn W. Dodwell, Bartlesville, OK (US)

Correspondence Address: RICHMOND, HITCHCOCK,, FISH & DOLLAR, P.O. Box 2443, Bartlesville, OK, 74005, US

(21) Appl. No.: 10/324,594

(22) Filed: Dec. 19, 2002

(51) Int. Cl. B01D 53/50

(52) U.S. Cl. 423/244.06; 502/407

(57) ABSTRACT

The attrition resistance of sorbent compositions are enhanced by controlling the particle size distribution of the perlite component of the sorbent.

### BACKGROUND OF THE INVENTION

This invention relates to a process of making a sorbent composition, a sorbent composition made by such process, and a process of using a sorbent composition for the removal of sulfur from a sulfur-containing fluid.

Hydrocarbon-containing fluids such as gasoline and diesel fuels typically contain a quantity of sulfur. High levels of sulfur in such automotive fuels are undesirable because oxides of sulfur present in automotive exhaust may irreversibly poison noble metal catalysts employed in automobile catalytic converters. Emissions from such poisoned catalytic converters may contain high levels of non-combusted hydrocarbons, oxides of nitrogen, and/or carbon monoxide, which, when catalyzed by sunlight, form ground level ozone, more commonly referred to as smog.

Much of the sulfur present in the final blend of most gasolines originates from a gasoline blending component commonly known as “cracked-gasoline.” Thus, reduction of sulfur levels in cracked-gasoline will inherently serve to reduce sulfur levels in most gasolines, such as, automobile gasolines, racing gasolines, aviation gasolines, boat gasolines, and the like.

Many conventional processes exist for removing sulfur from cracked-gasoline. However, most conventional sulfur removal processes, such as hydrodesulfurization, tend to saturate olefins and aromatics in the cracked-gasoline and thereby reduce its octane number (both research and motor octane number). Thus, there is a need for a process wherein desulfurization of cracked-gasoline is achieved while the octane number is maintained.

In addition to the need for removing sulfur from cracked-gasoline, there is also a need to reduce the sulfur content in diesel fuel. In removing sulfur from diesel fuel by hydrodesulfurization, the cetane is improved but there is a large cost in hydrogen consumption. Such hydrogen is consumed by both hydrodesulfurization and aromatic hydrogenation reactions. Thus, there is a need for a process wherein desulfurization of diesel fuel is achieved without significant consumption of hydrogen so as to provide a more economical desulfurization process.

Traditionally, sorbent compositions used in processes for removing sulfur from sulfur-containing fluids, such as cracked-gasoline and diesel fuel, have been agglomerates utilized in fixed bed applications. Because fluidized bed reactors have advantages over fixed bed reactors, such as better heat transfer and better pressure drop, sulfur-containing fluids are sometimes processed in fluidized bed reactors. Fluidized bed reactors generally use reactants (e.g., sorbent compositions) that are in the form of relatively small particulates. The size of these particulates is generally in a range of from about 1 micron to about 10 millimeters. However, conventional reactant particulates generally do not have sufficient attrition resistance (i.e., resistance to physical deterioration) for all applications. Consequently, finding a sorbent with sufficient attrition resistance that removes sulfur from these sulfur-containing fluids and that can be used in fluidized, transport, moving, or fixed bed reactors is desirable and would be a significant contribution to the art and to the economy.

### SUMMARY OF THE INVENTION

Accordingly, it is an object of the present invention to provide a novel method of making a sorbent composition which is suitable for removing sulfur from sulfur-containing fluids, such as cracked-gasoline and diesel fuels, and has enhanced attrition resistance.

A further object of this invention is to provide a sorbent composition having enhanced attrition resistance.

Another object of this invention is to provide a process for the removal of sulfur from sulfur-containing fluid streams which minimizes saturation of olefins and aromatics therein.

A yet further object of this invention is to provide a process for the removal of sulfur from sulfur-containing fluid streams which minimizes hydrogen consumption.

It should be noted that the above-listed objects need not all be accomplished by the invention claimed herein and other objects and advantages of this invention will be apparent from the following description of the preferred embodiments and appended claims.

Accordingly, in one embodiment of the present invention, a process for making a sorbent composition is provided. The process comprises the steps of: (a) separating an initial quantity of uncrushed expanded perlite particles into a large particle portion and a small particle portion; (b) crushing said small particle portion to obtain selectively crushed perlite particles having a mean particle size less than the mean particle size of the small particle portion; and (c) combining the selectively crushed perlite particles with zinc oxide and a promoter metal to form an unreduced sorbent.

In another embodiment of the present invention, a sorbent composition is provided. The sorbent composition comprises perlite, zinc oxide, and a reduced-valence promoter metal component. The perlite has a mean particle size in the range of from about 2 to about 30 microns and less than about 10 weight percent of the perlite has a particle size greater than about 75 microns.

In another embodiment of the present invention, there is provided a desulfurization process comprising the steps of: (a) contacting a sulfur-containing fluid with a sorbent in a desulfurization zone under desulfurization conditions sufficient to provide a desulfurized fluid and a sulfur-loaded sorbent, wherein the sorbent comprises perlite, zinc oxide, and a promoter metal component and wherein the perlite has a mean particle size in the range of from about 2 to about 30 microns and less than about 10 weight percent of the perlite has a particle size greater than about 75 microns; (b) contacting at least a portion of the sulfur-loaded sorbent with an oxygen-containing regeneration stream in a regeneration zone under regeneration conditions sufficient to provide a regenerated sorbent comprising an oxidized promoter metal component; (c) contacting at least a portion of the regenerated sorbent with a hydrogen-containing reducing stream in a reducing zone under reducing conditions sufficient to reduce at least a portion of the oxidized promoter metal component to said reduced-valence promoter metal component, thereby providing a reduced sorbent; and (d) recovering a desulfurized fluid.

### BRIEF DESCRIPTION OF THE DRAWINGS

FIG. 1 is a schematic diagram of a desulfurization unit, particularly illustrating the circulation of regenerable solid sorbent particulates through a reactor, a regenerator, and a reducer.

FIG. 2 is a plot showing the particle size distributions of two commercially available perlite materials employed in Examples 1 and 2.

FIG. 3 is a schematic diagram of a system used in Examples 1 and 2 to determine the Operational Jet Cup Attrition Index of a sorbent composition.

### DETAILED DESCRIPTION OF THE PREFERRED EMBODIMENTS

In accordance with a first embodiment of the present invention, a novel process for making a sorbent composition is provided. The process generally comprises the steps of: (a) separating an initial quantity of uncrushed perlite particles into a large particle portion and a small particle portion; (b) crushing the small particle portion to obtain selectively crushed perlite particles having a mean particle size less than the mean particle size of the small particle portion; (c) combining support components including the selectively crushed perlite, a zinc source, an aluminum source, and a solvent (and, optionally, a filler); (d) mixing the support components to provide a substantially homogeneous support mixture in the form of a slurry; (e) shaping the support mixture into support particulates by spray drying the support mixture into microspherical particles; (f) calcining the support particulates to thereby provide calcined support particulates having a zinc aluminate component formed from at least a portion of the zinc source and at least a portion of the aluminum source; (g) incorporating a promoter metal with the calcined support particulates by impregnation with an aqueous solution containing the promoter metal, thereby providing a promoted sorbent; (h) calcining the promoted sorbent to thereby provide a calcined promoted sorbent having an oxidized promoter metal component comprising a substitutional solid metal oxide solution characterized by the following formula: M_{X}Zn_{Y}O, wherein M is the promoter metal and X and Y are numerical values in the range of from 0.01 to 0.99; (i) reducing the calcined promoted sorbent to thereby provide a reduced sorbent having a reduced-valence promoter metal component comprising a substitutional solid metal solution characterized by the following formula: M_{A}Zn_{B}, wherein M is the promoter metal and A and B are numerical values in the range of from about 0.01 to about 0.99.

The expanded perlite employed in step (a), described above, is preferably formed from a siliceous volcanic rock (i.e., crude perlite) that has been heated to a temperature above 1,600° F. to thereby cause expansion of the rock to a size that is at least four times its initial size. Crude perlite rock expands (typically four to 20 times its original size) at high temperatures due to the presence of water in the rock. When the crude perlite is heated above 1,600° F., the water in the rock vaporizes and creates numerous tiny bubbles in the heat-softened glassy particles. These diminutive glass-sealed bubbles account for the low density of expanded perlite. Expanded perlite typically has a density in the range of from about one to about 15 pounds per cubic foot, more typically two to six pounds per cubic foot. An elemental analysis of expanded perlite typically shows the following components in approximately the following amounts: silicon, 33.8%; aluminum, 7.2%; potassium, 3.5%; sodium, 3.4%; iron, 0.6%; calcium, 0.6%; magnesium, 0.2%; oxygen (by difference), 47.5%; and bound water, 3.0%. Preferably, the initial quantity of uncrushed expanded perlite employed in the present invention comprises the above-listed components in amounts within about 25 percent of the above-listed amounts, more preferably in amounts within 10 percent of the above-listed amounts.

The initial quantity of expanded perlite employed in step (a), described above, should be “uncrushed” microspheres of expanded perlite. It is important for the expanded perlite to be uncrushed because commercially available crushed perlite material comprises irregularly shaped particles with jagged edges that are difficult to size and separate using conventional methods (e.g., sieving). Further, commercially available crushed perlite material does not have a particle size distribution sufficient to provide the enhanced attrition resistance provided by the present invention. It has also been discovered that additional crushing of commercially available crushed expanded perlite in an effort to obtain the desired reduced mean particle size produces an excessive amount of very small (e.g., <2 micron) perlite particles. Such an excess of very small perlite particles undesirably increases the density of the perlite, thereby making it unsuitable for use as a porosity enhancer in the inventive sorbent compositions described herein. As opposed to commercially available crushed expanded perlite, the uncrushed expanded perlite particles employed in step (a) have a generally regular microspherical shape which allows for easy and accurate separation by particle size via conventional separation methods.

The initial quantity of uncrushed expanded perlite employed in the present invention preferably comprises substantially microspherical expanded perlite particles having a mean particle size in the range of from about 10 to about 100 microns, more preferably in the range of from about 20 to about 60 microns, and most preferably in the range of from 25 to 50 microns. Preferably, at least about five weight percent of the uncrushed expanded perlite has a particle size of more than 75 microns, more preferably about 10 to about 90 weight percent of the uncrushed expanded perlite has a particle size of more than 75 microns, and most preferably 20 to 80 weight percent of the uncrushed expanded perlite has a particle size of more than 75 microns. Preferably, at least about five weight percent of the uncrushed expanded perlite has a particle size of less than 75 microns, more preferably about 10 to about 90 weight percent of the uncrushed expanded perlite has a particle size of less than 75 microns, and most preferably 20 to 80 weight percent of the uncrushed expanded perlite has a particle of size less than 75 microns. Preferably, the amount of the uncrushed expanded perlite having a particle size greater than 170 microns is less than about 15 weight percent, more preferably less than about five weight percent, and most preferably less than two weight percent. Preferably, the amount of uncrushed expanded perlite having a particle size less than three microns is less than about 15 weight percent, more preferably less than about five weight percent, and most preferably less than two weight percent.

The separation of the uncrushed expanded perlite into a small particle portion and a large particle portion, described above in step (a), can be performed by any means known in the art for separating substantially microspherical solid particles by particle size. Preferably, the uncrushed expanded perlite is separated by sieving with a 120-350 mesh sieve (125-about 42 μm), more preferably a 150-280 mesh sieve (about 99-about 51 μm), still more preferably a 180-225 (about 83-65 μm) mesh sieve, even more preferably a 190-210 mesh sieve (about 79-about 70 μm), and most preferably a 200 mesh sieve (74 μm). During separation, the uncrushed expanded perlite particles are separated into particles larger than a separation point particle size (i.e., the large particle portion) and particles smaller than the separation point particle size (i.e., the small particle portion). Preferably, the separation point particle size is in the range of from about 25 to about 125 microns, more preferably about 50 to about 100 microns, still more preferably about 65 to about 85 microns, even more preferably 70 to 80 microns, and most preferably about 75 microns.

It is preferred for the small particle portion of the uncrushed expanded perlite to have a mean particle size in the range of from about 10 to about 60 microns, more preferably in the range of from about 20 to about 50 microns, and most preferably in the range of from 30 to 40 microns. Preferably, the amount of the small particle portion having a particle size of more than 75 microns is less than about 15 weight percent, more preferably less than about five weight percent, and most preferably less than two weight percent. Preferably, the amount of the small particle portion having a particle size of less than three microns is less than about 15 weight percent, more preferably less than about five weight percent, and most preferably less than two weight percent.

The crushing of the small particle portion of the uncrushed expanded perlite, described in step (b) above, can be performed by any means known in the art for providing selectively crushed expanded perlite particles having the desired particle size distribution. As used herein, the term “selectively crushed expanded perlite” refers to expanded perlite that has been subjected to the separation of large particles therefrom prior to crushing the remaining smaller particles. It is preferred for the crushing of step (b) to reduce the mean particle size of the small particle portion to less than about 80 percent of its original mean particle size, more preferably to less than about 50 percent of its original mean particle size, and most preferably to less than 30 percent of its original mean particle size. The selectively crushed expanded perlite preferably has a mean particle size in the range of from about two to about 40 microns, more preferably from about four to about 35 microns, and most preferably from eight to 30 microns. Preferably, the amount of the selectively crushed expanded perlite having a particle size greater than 75 microns is less than about 11 weight percent, more preferably less than about four weight percent, and most preferably less than two weight percent. Preferably, the amount of the selectively crushed expanded perlite having a particle size of less than two microns is less than about 15 weight percent, more preferably less than about five weight percent, and most preferably less than two weight percent. It has been discovered that employing a selectively crushed expanded perlite having the foregoing properties enhances the attrition resistance of the resulting sorbent product.

The zinc source employed in step (c), described above, can be any zinc-containing compound. Preferably, the zinc source is in the form of zinc oxide or one or more zinc compounds that are convertible to zinc oxide. Most preferably, the zinc source is in the form of a powdered zinc oxide. The zinc source, preferably powdered zinc oxide, will generally be present in the support mixture in an amount in the range of from about two to about 70 weight percent based on a total weight of the support mixture, more preferably in the range of from about five to about 50 weight percent, and most preferably in the range of from 10 to 30 weight percent.

The aluminum source employed in step (c), described above, can be any aluminum-containing carrier compound. The aluminum source can be any suitable commercially available alumina material including, but not limited to, colloidal alumina solutions, hydrated aluminas, peptized aluminas, and, generally, those alumina compounds produced by the dehydration of alumina hydrates. The preferred alumina source is a hydrated alumina such as, for example, boehmite or pseudoboehmite. The aluminum source, preferably a hydrated alumina, will generally be present in the support mixture in an amount such that the weight ratio of the zinc source to the aluminum source in the support mixture is in the range of from about 0.5:1 to about 20:1, more preferably in the range of from about 1:1 to about 10:1, and most preferably in the range of from 2:1 to 6:1.

The selectively crushed perlite employed in step (b), described above, should be present in the support mixture in an amount such that the weight ratio of the zinc source to the selectively crushed perlite is in the range of from about 0.5:1 to about 20:1, more preferably in the range of from 1:1 to about 10:1, and most preferably in the range of from 2:1 to 6:1.

The solvent employed in step (c), described above, can be any liquid added to the support mixture to help form a support mixture having an optimum consistency for shaping, preferably by spray drying. The most preferred solvent is distilled water. The solvent, preferably distilled water, should be present in the support mixture in an amount such that the weight ratio of the zinc source to the solvent is in the range of from about 0.05:1 to about 2:1, more preferably in the range of from about 0.1:1 to about 1:1, and most preferably in the range of from 0.2:1 to 0.5:1.

When a filler is employed in step (c), described above, the filler can be any compound which enhances the ability of the support mixture to be spray dried. Preferably, the filler is a clay such as, for example, kaolin clay. When the support mixture includes a filler, preferably kaolin clay, the filler should be present in the support mixture in an amount which provides a weight ratio of the zinc source to the filler in the range of from about 0.5:1 to about 20:1, more preferably in the range of from about 1:1 to about 10:1, and most preferably in the range of from 2:1 to 6:1.

In accordance with step (d), described above, the combined support components are generally mixed by any suitable method or manner which provides for the intimate mixing of such components to thereby provide a substantially homogeneous mixture of the support components. Any suitable means for mixing the support components can be used to achieve the desired dispersion of such components. Examples of suitable mixing means include, but are not limited to, mixing tumblers, stationery shells or troughs. Muller mixers, which are of the batch or continuous type, impact mixers, and the like. It is presently preferred to use a Muller mixer in the mixing of the support components. The support components are admixed to provide a resulting support mixture which can be in the form selected from the group consisting of a wet mix, a dough, a paste, a slurry, and the like.

In accordance with step (e), described above, the resulting support mixture can then be shaped to form a particulate(s) selected from the group consisting of a granulate, an extrudate, a tablet, a sphere, a pellet, a microsphere, and the like. Preferably, the support mixture is in the form of a slurry, and the shaping of the slurry into particulates is achieved by spray drying the slurry to form microspheres having a mean particle size generally in the range of from about 10 microns to about 300 microns, preferably in the range of from about 40 microns to about 150 microns, and most preferably in the range of from 50 to 100 microns. Spray drying is known in the art and is discussed in Perry's Chemical Engineers Handbook, 6th Edition, published by McGraw-Hill, Inc. at pages 20-58. Additional information can be obtained from the Handbook of Industrial Drying, published by Marcel Dekker, Inc. at pages 243-293.

After shaping, preferably spray drying, the support particulates are preferably dried and calcined in accordance with step (f), described above. Any drying method(s) known to one skilled in the art such as, for example, air drying, heat drying, vacuum drying, and the like and combinations thereof, can be used. Preferably, the support particulates are dried at a temperature in the range of from about 180° F. to about 290° F., more preferably in the range of from 200° F. to 270° F. The pressure employed during drying of the support particulates can be in the range of from about atmospheric (i.e., 14.7 pounds per square inch absolute) to about 150 pounds per square inch absolute (psia), more preferably in the range of from about atmospheric to about 100 psia, and most preferably about atmospheric, so long as the desired temperature can be maintained. Any suitable period for drying the support particulates can be employed. Preferably, the drying of the support particulates takes place during a time period in the range of from about 0.5 hour to about 60 hours, more preferably in the range of from 1.5 hours to 20 hours.

The calcining of the dried support particulates can be performed in an oxygen environment, such as, for example, air, at a calcination temperature in the range of from about 400° F. to about 1800° F., more preferably in the range of from about 600° F. to about 1600° F., and most preferably in the range of from 800° F. to 1500° F. The calcination pressure is preferably in the range of from about seven psia to about 750 psia, more preferably in the range of from about seven psia to about 450 psia, and most preferably in the range of from seven psia to 150 psia. The time period for the calcination of the dried support particulates is generally in the range of from about one hour to about 60 hours, more preferably in the range of from about two hours to about 20 hours, and most preferably in the range of from three hours to 15 hours.

During calcination of the support particulates, at least a portion of the zinc source and at least of portion of the aluminum source chemically combine to form zinc aluminate (ZnAl₂O₄). The calcined support particulates preferably comprise zinc aluminate in an amount in the range of from about two to about 40 weight percent based on the total weight of the calcined support particulates, more preferably in the range of from about five to about 30 weight percent, and most preferably in the range of from 10 to 20 weight percent.

In accordance with step (g), described above, the resulting calcined support particulates can then be contacted with a promoter metal source to thereby incorporate the promoter metal with the calcined support particulates. The promoter metal can be at least one metal selected from the group consisting of nickel, cobalt, iron, manganese, tungsten, silver, gold, copper, platinum, zinc, tin, ruthenium, molybdenum, antimony, vanadium, iridium, chromium, palladium, and rhodium. Most preferably, the promoter metal is nickel. The promoter metal may be incorporated on, in, or with the calcined support particulates by any suitable means or method known in the art such as, for example, impregnating, soaking, spraying, and combinations thereof. The preferred method of incorporating the promoter metal with the calcined support particulates is impregnating using standard incipient wetness impregnation techniques. A preferred impregnation method employs an impregnation solution comprising the desired concentration of the promoter metal so as to ultimately provide a promoted sorbent comprising the desired quantity of the promoter metal. The impregnation solution can be an aqueous solution formed by dissolving the promoter metal source in a solvent, preferably water. It is acceptable to use somewhat of an acidic solution to aid in the dissolution of the promoter metal source. It is most preferred for the calcined support particulates to be impregnated with the promoter metal by using a solution containing nickel nitrate hexahydrate dissolved in water.

Generally, the amount of the promoter metal incorporated, preferably impregnated, onto, into or with the calcined support particulates, is an amount which provides, after the promoted sorbent particulate material has been dried and calcined, a promoted sorbent composition comprising the promoter metal in an amount in the range of from about one to about 60 weight percent promoter metal based on the total weight of the promoted sorbent, preferably an amount in the range of from about five to about 50 weight percent promoter metal, and most preferably in an amount in the range of from 10 to 40 weight percent promoter metal. It may be necessary to employ one or more incorporation steps in order to incorporate the desired quantity of the promoter metal with the calcined support particulates. If so, such additional incorporation(s) are performed in substantially the same manner as described above.

Once the promoter metal has been incorporated on, in, or with the calcined support particulates, the promoted sorbent particulates are then dried and calcined in accordance with step (h), described above. The drying and calcining of the promoted sorbent particulates can be accomplished by any suitable method(s) known in the art. Preferably, the drying and calcining of the promoted sorbent particulates is performed in substantially the same manner and under substantially the same conditions as previously described with reference to the drying and calcining of the unpromoted support particulates.

When the promoted sorbent particulates are calcined, at least a portion of the promoter metal and at least a portion of the zinc oxide present in the promoted sorbent chemically combine to form an oxidized promoter metal component. Preferably, the oxidized promoter metal component comprises, consists essentially of, or consists of a substitutional solid metal oxide solution characterized by the formula: M_{X}Zn_{Y}O, wherein M is the promoter metal and X and Y are each numerical values in the range of from about 0.01 to about 0.99. In the above formula, it is preferred for X to be in the range of from about 0.5 to about 0.9 and most preferably from 0.6 to 0.8. It is further preferred for Y to be in the range of from about 0.1 to about 0.5, and most preferably from 0.2 to 0.4. Preferably, Y is equal to (1-X).

Substitutional solid solutions have unique physical and chemical properties that are important to the chemistry of the sorbent composition described herein. Substitutional solid solutions are a subset of alloys that are formed by the direct substitution of the solute metal for the solvent metal atoms in the crystal structure. For example, it is believed that the substitutional solid metal oxide solution (M_{X}Zn_{Y}O) found in the oxidized (i.e., unreduced state), calcined sorbent composition made by the process of the present invention is formed by the solute zinc metal atoms substituting for the solvent promoter metal atoms. There are three basic criteria that favor the formation of substitutional solid solutions: (1) the atomic radii of the two elements are within 15 percent of each other; (2) the crystal structures of the two pure phases are the same; and (3) the electronegativities of the two components are similar. The promoter metal (as the elemental metal or metal oxide) and zinc oxide employed in the inventive sorbent composition preferably meet at least two of the three criteria set forth above. For example, when the promoter metal is nickel, the first and third criteria, are met, but the second is not. The nickel and zinc metal atomic radii are within 10 percent of each other and the electronegativities are similar. However, nickel oxide (NiO) preferentially forms a cubic crystal structure, while zinc oxide (ZnO) prefers a hexagonal crystal structure. A nickel zinc oxide solid solution retains the cubic structure of the nickel oxide. Forcing the zinc oxide to reside in the cubic structure increases the energy of the phase, which limits the amount of zinc that can be dissolved in the nickel oxide structure. This stoichiometry control manifests itself microscopically in a 70:30 nickel zinc oxide solid solution (Ni_{0.7}Zn_{0.3}O) that is formed during oxidation (i.e., calcination or regeneration) and microscopically in the repeated regenerability of the sorbent.

During calcination of the promoted sorbent particulates, at least a portion of the promoter metal combines with at least a portion of the zinc aluminate to form a promoter metal-zinc aluminate substitutional solid solution characterized by the formula: M_{Z}Zn_{(1-Z)}Al₂O₄), wherein Z is a numerical value in the range of from 0.01 to 0.99.

The calcined promoted sorbent particulates preferably comprise zinc oxide, the oxidized promoter metal component (M_{X}Zn_{Y}O), perlite, and the promoter metal-zinc aluminate (M_{Z}Zn_{(1-Z)}Al₂O₄) in the ranges provided below in Table 1.

TABLE 1
Components of the Calcined Promoted Sorbent Particulates

| | | M_{X}Zn_{Y}O | Perlite | M_{Z}Zn_{(1-z)}Al₂O₄ |
|---|---|---|---|---|
| Range | ZnO (wt %) | (wt %) | (wt %) | (wt %) |
| Preferred | 5-80 | 5-70 | 2-50 | 1-50 |
| More Preferred | 20-60 | 7-60 | 5-30 | 5-30 |
| Most Preferred | 30-50 | 10-40 | 10-20 | 10-20 |

In accordance with step (i), described above, the calcined promoted sorbent particulates are thereafter subjected to reduction with a suitable reducing agent, preferably hydrogen, under reducing conditions, to thereby provide a reduced sorbent composition. Reduction can be carried out at a temperature in the range of from about 100° F. to about 1500° F. and a pressure in the range of from about 15 psia to about 1500 psia. Such reduction can be carried out for a time period sufficient to achieve the desired level of reduction, generally a time period in the range of from about 0.1 hour to about 20 hours.

During reduction of the calcined promoted sorbent particulates, at least a portion of the oxidized promoter metal component is reduced to provide a reduced-valence promoter metal component. Preferably the reduced-valence promoter metal component comprises, consists essentially of, or consists of a substitutional solid metal solution characterized by the formula: M_{A}Zn_{B}, wherein M is the promoter metal and A and B are numerical values in the range of from about 0.01 to about 0.99. In the above formula for the substitutional solid metal solution, it is preferred for A to be in the range of from about 0.70 to about 0.97, more preferably in the range of from about 0.80 to about 0.95, and most preferably in the range of from about 0.90 to about 0.94. It is further preferred for B to be in the range of from about 0.03 to about 0.30, more preferably in the range of from about 0.05 to about 0.20, and most preferably in the range of from about 0.06 to 0.10. Preferably, B is equal to (1-A). As used herein, the term “reduced-valence promoter metal component” shall denote a promoter metal-containing component that initially had one or more oxygen atoms associated with it, but now has a reduced number of oxygen atoms associated with it due to reduction. Preferably, a substantial portion of the reduced-valence promoter metal component has no oxygen atoms associated with it.

The reduced sorbent particulates preferably comprise zinc oxide, the reduced-valence promoter metal component (M_{A}Zn_{B}), perlite, and the promoter metal-zinc aluminate substitutional solid (M_{Z}Zn_{(1-Z)}Al₂O₄) in the ranges provided below in Table 2.

TABLE 2
Components of the Reduced Sorbent Particulates

| | | M_{A}Zn_{B} | | M_{Z}Zn_{(1-z)}Al₂O₄ |
|---|---|---|---|---|
| Range | ZnO (wt %) | (wt %) | Perlite (wt %) | (wt %) |
| Preferred | 5-80 | 5-80 | 2-50 | 1-50 |
| More Preferred | 20-60 | 7-60 | 5-30 | 5-30 |
| Most Preferred | 30-50 | 10-40 | 10-20 | 10-20 |

The physical properties of the reduced sorbent particulates significantly affect its suitability for use in the desulfurization process, described in detail below. Important physical properties of the reduced sorbent particulates include, for example, particle shape, particle size, particle density, and resistance to attrition.

The reduced sorbent particulates preferably have high resistance to attrition. As used herein, the term “attrition resistance” denotes a measure of a particle's resistance to size reduction under controlled conditions of turbulent motion. The attrition resistance of a particle can be quantified using the jet cup attrition test, similar to the Davison Index. The Jet Cup Attrition Index represents the weight percent of the over 44 micrometer (μ) particle size fraction which is reduced to particle sizes of less than 37 micrometers under test conditions and involves screening a 5 gram sample of sorbent to remove particles in the 0 to 44 micrometer size range. The particles above 44 micrometers are then subjected to a tangential jet of air at a rate of 21 liters per minute introduced through a 0.0625 inch orifice fixed at the bottom of a specially designed jet cup (1″ I.D.×2″ height) for a period of 1 hour. The jet cup attrition test is calculated as follows:

$$DI = \frac{Wt . of 0 - 37 Micrometer Formed During Test}{Wt . of Original + 44 Micrometer Fraction Being Tested} \times 100 \times Correction Factor$$

The Correction Factor (presently 0.3) is determined by using a known calibration standard to adjust for differences in jet cup dimensions and wear. The solid sorbent particulates employed in the present invention preferably have a jet cup attrition index value of less than of less than about 20, more preferably less than about 15, still more preferably less than about 12, and most preferably less than 10.

The reduced sorbent particulates preferably comprise substantially microspherical particles having a mean particle size in the range of from about 20 to about 300 microns, more preferably in the range of from about 40 to 150 microns, and most preferably in the range of from 50 to 100 microns. The density of the sorbent particulates is preferably in the range of from about 0.5 to about 1.5 grams per cubic centimeter (g/cc), more preferably in the range of from about 0.8 to about 1.3 g/cc, and most preferably in the range of from 0.9 to 1.2 g/cc. The particle size and density of the sorbent particulates preferably qualify the sorbent particulates as a Group A solid under the Geldart group classification system described in Powder Technol., 7, 285-292 (1973).

In accordance with another embodiment of the present invention, a sorbent composition prepared in accordance with the above-described procedure can be employed in a desulfurization unit to remove sulfur from a sulfur-containing fluid.

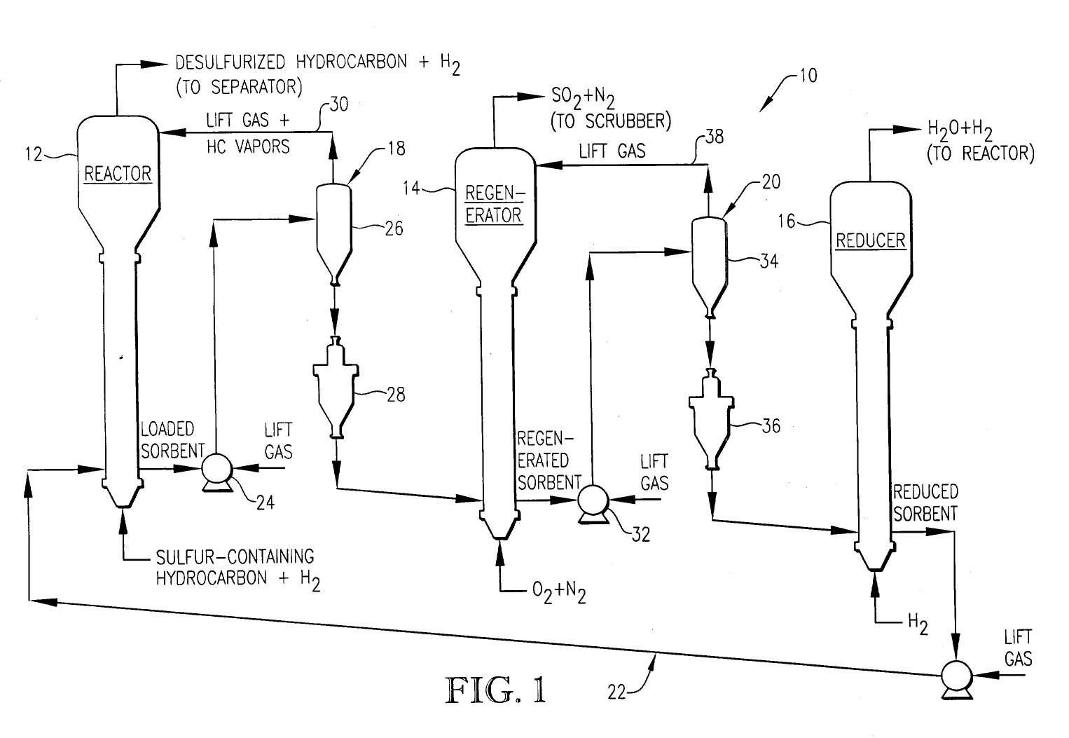

Referring to FIG. 1, a desulfurization unit 10 is illustrated as generally comprising a fluidized bed reactor 12, a fluidized bed regenerator 14, and a fluidized bed reducer 16. Solid sorbent particulates are circulated in desulfurization unit 10 to provide for substantially continuous sulfur removal from a sulfur-containing hydrocarbon, such as cracked-gasoline or diesel fuel. The sorbent particulates employed in desulfurization unit 10 are preferably sorbent particulates made by the sorbent preparation process described above in the first embodiment of the present invention.

In fluidized bed reactor 12, a hydrocarbon-containing fluid stream is passed upwardly through a bed of the reduced sorbent particulates. The reduced sorbent particulates contacted with the hydrocarbon-containing stream in reactor 12 preferably initially (i.e., immediately prior to contacting with the hydrocarbon-containing fluid stream) comprise perlite, zinc oxide, and the reduced-valence promoter metal component. Though not wishing to be bound by theory, it is believed that the reduced-valence promoter metal component of the reduced sorbent particulates facilitates the removal of sulfur from the hydrocarbon-containing stream, while the zinc oxide operates as a sulfur storage mechanism via its conversion to zinc sulfide. The reduced-valence promoter metal component has a valence which is less than the valence of the promoter metal component in its common oxidized state. More specifically, the reduced sorbent particulates employed in reactor 12 should include a promoter metal component having a valence which is less than the valence of the promoter metal component of the regenerated (i.e., oxidized) sorbent particulates exiting regenerator 14.

The hydrocarbon-containing fluid stream contacted with the reduced sorbent particulates in reactor 12 preferably comprises a sulfur-containing hydrocarbon and hydrogen. The molar ratio of the hydrogen to the sulfur-containing hydrocarbon charged to reactor 12 is preferably in the range of from about 0.1:1 to about 3:1, more preferably in the range of from about 0.2:1 to about 1:1, and most preferably in the range of from 0.4:1 to 0.8:1. Preferably, the sulfur-containing hydrocarbon is a fluid which is normally in a liquid state at standard temperature and pressure, but which exists in a gaseous state when combined with hydrogen, as described above, and exposed to the desulfurization conditions in reactor 12. The sulfur-containing hydrocarbon preferably can be used as a fuel or a precursor to fuel. Examples of suitable sulfur-containing hydrocarbons include cracked-gasoline, diesel fuels, jet fuels, straight-run naphtha, straight-run distillates, coker gas oil, coker naphtha, alkylates, and straight-run gas oil. Most preferably, the sulfur-containing hydrocarbon comprises a hydrocarbon fluid selected from the group consisting of gasoline, cracked-gasoline, diesel fuel, and mixtures thereof.

As used herein, the term “gasoline” denotes a mixture of hydrocarbons boiling in a range of from about 100° F. to about 430° F., or any fraction thereof. Examples of suitable gasolines include, but are not limited to, hydrocarbon streams in refineries such as naphtha, straight-run naphtha, coker naphtha, catalytic gasoline, visbreaker naphtha, alkylates, isomerate, reformate, and the like, and mixtures thereof.

As used herein, the term “cracked-gasoline” denotes a mixture of hydrocarbons boiling in a range of from about 100° F. to about 430° F., or any fraction thereof, that are products of either thermal or catalytic processes that crack larger hydrocarbon molecules into smaller molecules. Examples of suitable thermal processes include, but are not limited to, coking, thermal cracking, visbreaking, and the like, and combinations thereof. Examples of suitable catalytic cracking processes include, but are not limited to, fluid catalytic cracking, heavy oil cracking, and the like, and combinations thereof. Thus, examples of suitable cracked-gasolines include, but are not limited to, coker gasoline, thermally cracked gasoline, visbreaker gasoline, fluid catalytically cracked gasoline, heavy oil cracked-gasoline and the like, and combinations thereof. In some instances, the cracked-gasoline may be fractionated and/or hydrotreated prior to desulfurization when used as the sulfur-containing fluid in the process in the present invention.

As used herein, the term “diesel fuel” denotes a mixture of hydrocarbons boiling in a range of from about 300° F. to about 750° F., or any fraction thereof. Examples of suitable diesel fuels include, but are not limited to, light cycle oil, kerosene, jet fuel, straight-run diesel, hydrotreated diesel, and the like, and combinations thereof.

The sulfur-containing hydrocarbon described herein as suitable feed in the inventive desulfurization process comprises a quantity of olefins, aromatics, and sulfur, as well as paraffins and naphthenes. The amount of olefins in gaseous cracked-gasoline is generally in a range of from about 10 to about 35 weight percent olefins based on the total weight of the gaseous cracked-gasoline. For diesel fuel there is essentially no olefin content. The amount of aromatics in gaseous cracked-gasoline is generally in a range of from about 20 to about 40 weight percent aromatics based on the total weight of the gaseous cracked-gasoline. The amount of aromatics in gaseous diesel fuel is generally in a range of from about 10 to about 90 weight percent aromatics based on the total weight of the gaseous diesel fuel. The amount of atomic sulfur in the sulfur-containing hydrocarbon fluid, preferably cracked-gasoline or diesel fuel, suitable for use in the inventive desulfurization process is generally greater than about 50 parts per million by weight (ppmw) of the sulfur-containing hydrocarbon fluid, more preferably in a range of from about 100 ppmw atomic sulfur to about 10,000 ppmw atomic sulfur, and most preferably from 150 ppmw atomic sulfur to 500 ppmw atomic sulfur. It is preferred for at least about 50 weight percent of the atomic sulfur present in the sulfur-containing hydrocarbon fluid employed in the present invention to be in the form of organosulfur compounds. More preferably, at least about 75 weight percent of the atomic sulfur present in the sulfur-containing hydrocarbon fluid is in the form of organosulfur compounds, and most preferably at least 90 weight percent of the atomic sulfur is in the form of organosulfur compounds. As used herein, “sulfur” used in conjunction with “ppmw sulfur” or the term “atomic sulfur”, denotes the amount of atomic sulfur (about 32 atomic mass units) in the sulfur-containing hydrocarbon, not the atomic mass, or weight, of a sulfur compound, such as an organosulfur compound.

As used herein, the term “sulfur” denotes sulfur in any form normally present in a sulfur-containing hydrocarbon such as cracked-gasoline or diesel fuel. Examples of such sulfur which can be removed from a sulfur-containing hydrocarbon fluid through the practice of the present invention include, but are not limited to, hydrogen sulfide, carbonal sulfide (COS), carbon disulfide (CS₂), mercaptans (RSH), organic sulfides (R—S—R), organic disulfides (R—S—S—R), thiophene, substitute thiophenes, organic trisulfides, organic tetrasulfides, benzothiophene, alkyl thiophenes, alkyl benzothiophenes, alkyl dibenzothiophenes, and the like, and combinations thereof, as well as heavier molecular weights of the same which are normally present in sulfur-containing hydrocarbons of the types contemplated for use in the desulfurization process of the present invention, wherein each R can by an alkyl, cycloalkyl, or aryl group containing one to 10 carbon atoms.

As used herein, the term “fluid” denotes gas, liquid, vapor, and combinations thereof.

As used herein, the term “gaseous” denotes the state in which the sulfur-containing hydrocarbon fluid, such as cracked-gasoline or diesel fuel, is primarily in a gas or vapor phase.

In fluidized bed reactor 12, the reduced sorbent particulates are contacted with the upwardly flowing gaseous hydrocarbon-containing fluid stream under a set of desulfurization conditions sufficient to produce a desulfurized hydrocarbon and sulfur-loaded sorbent particulates. The flow of the hydrocarbon-containing fluid stream is sufficient to fluidize the bed of sorbent particulates located in reactor 12. The desulfurization conditions in reactor 12 include temperature, pressure, weighted hourly space velocity (WHSV), and superficial velocity. The preferred ranges for such desulfurization conditions are provided below in Table 3.

TABLE 3
Desulfurization Conditions

| | | | WHSV | Superficial Vel. |
|---|---|---|---|---|
| Range | Temp (° F.) | Press. (psig) | (hr⁻¹⁾ | (ft/s) |
| Preferred | 250-1200 | 25-750 | 1-20 | 0.25-5 |
| More Preferred | 500-1000 | 100-400 | 2-12 | 0.5-2.5 |
| Most Preferred | 700-850 | 150-250 | 3-8 | 1-2 |

When the reduced sorbent particulates are contacted with the hydrocarbon-containing stream in reactor 12 under desulfurization conditions, sulfur compounds, particularly organosulfur compounds, present in the hydrocarbon-containing fluid stream are removed from such fluid stream. At least a portion of the sulfur removed from the hydrocarbon-containing fluid stream is employed to convert at least a portion of the zinc oxide of the reduced solid sorbent particulates into zinc sulfide.

In contrast to many conventional sulfur removal processes (e.g., hydrodesulfurization), it is preferred that substantially none of the sulfur in the sulfur-containing hydrocarbon fluid is converted to, and remains as, hydrogen sulfide during desulfurization in reactor 12. Rather, it is preferred that the fluid effluent from reactor 12 (generally comprising the desulfurized hydrocarbon and hydrogen) comprises less than the amount of hydrogen sulfide, if any, in the fluid feed charged to reactor 12 (generally comprising the sulfur-containing hydrocarbon and hydrogen). The fluid effluent from reactor 12 preferably contains less than about 50 weight percent of the amount of sulfur in the fluid feed charged to reactor 12, more preferably less than about 20 weight percent of the amount of sulfur in the fluid feed, and most preferably less than five weight percent of the amount of sulfur in the fluid feed. It is preferred for the total sulfur content of the fluid effluent from reactor 12 to be less than about 50 parts per million by weight (ppmw) of the total fluid effluent, more preferably less than about 30 ppmw, still more preferably less than about 15 ppmw, and most preferably less than 10 ppmw.

After desulfurization in reactor 12, the desulfurized hydrocarbon fluid, preferably desulfurized cracked-gasoline or desulfurized diesel fuel, can thereafter be separated and recovered from the fluid effluent and preferably liquified. The liquification of such desulfurized hydrocarbon fluid can be accomplished by any method or manner known in the art. The resulting liquefied, desulfurized hydrocarbon preferably comprises less than about 50 weight percent of the amount of sulfur in the sulfur-containing hydrocarbon (e.g., cracked-gasoline or diesel fuel) charged to the reaction zone, more preferably less than about 20 weight percent of the amount of sulfur in the sulfur-containing hydrocarbon, and most preferably less than five weight percent of the amount of sulfur in the sulfur-containing hydrocarbon. The desulfurized hydrocarbon preferably comprises less than about 50 ppmw sulfur, more preferably less than about 30 ppmw sulfur, still more preferably less than about 15 ppmw sulfur, and most preferably less than 10 ppmw sulfur.

After desulfurization in reactor 12, at least a portion of the sulfur-loaded sorbent particulates are transported to regenerator 14 via a first transport assembly 18. In regenerator 14, the sulfur-loaded solid sorbent particulates are contacted with an oxygen-containing regeneration stream. The oxygen-containing regeneration stream preferably comprises at least one mole percent oxygen with the remainder being a gaseous diluent. More preferably, the oxygen-containing regeneration stream comprises in the range of from about one to about 50 mole percent oxygen and in the range of from about 50 to about 95 mole percent nitrogen, still more preferable in the range of from about two to about 20 mole percent oxygen and in the range of from about 70 to about 90 mole percent nitrogen, and most preferably in the range of from three to 10 mole percent oxygen and in the range of from 75 to 85 mole percent nitrogen.

The regeneration conditions in regenerator 14 are sufficient to convert at least a portion of the zinc sulfide of the sulfur-loaded sorbent particulates into zinc oxide via contacting with the oxygen-containing regeneration stream. The preferred ranges for such regeneration conditions are provided below in Table 4.

TABLE 4
Regeneration Conditions

| | Temp | Press. | Superficial Vel. |
|---|---|---|---|
| Range | (° F.) | (psig) | (ft/s) |
| Preferred | 500-1500 | 10-250 | 0.5-10 |
| More Preferred | 700-1200 | 20-150 | 1.0-5.0 |
| Most Preferred | 900-1100 | 30-75 | 2.0-2.5 |

When the sulfur-loaded sorbent particulates are contacted with the oxygen-containing regeneration stream under the regeneration conditions described above, at least a portion of the promoter metal component is oxidized to form the oxidized promoter metal component. Preferably, in regenerator 14 the substitutional solid metal solution (M_{A}Zn_{B}) and/or sulfided substitutional solid metal solution (M_{A}Zn_{B}S) of the sulfur-loaded sorbent is converted to the substitutional solid metal oxide solution (M_{X}Zn_{Y}O).

The regenerated sorbent particulates exiting regenerator 14 preferably comprise zinc oxide, the oxidized promoter metal component (M_{X}Zn_{Y}O), perlite, and the promoter metal-zinc aluminate (M_{Z}Zn_{(1-Z)}Al₂O₄) in the ranges provided below in Table 5.

TABLE 5
Components of the Regenerated Sorbent Particulates

| | | M_{X}Zn_{Y}O | Perlite | M_{Z}Zn_{(1-z)}Al₂O₄ |
|---|---|---|---|---|
| Range | ZnO (wt %) | (wt %) | (wt %) | (wt %) |
| Preferred | 5-80 | 5-70 | 2-50 | 1-50 |
| More Preferred | 20-60 | 7-60 | 5-30 | 5-30 |
| Most Preferred | 30-50 | 10-40 | 10-20 | 10-20 |

After regeneration in regenerator 14, the regenerated (i.e., oxidized) sorbent particulates are transported to reducer 16 via a second transport assembly 20. In reducer 16, the regenerated sorbent particulates are contacted with a hydrogen-containing reducing stream. The hydrogen-containing reducing stream preferably comprises at least about 50 mole percent hydrogen with the remainder being cracked hydrocarbon products such as, for example, methane, ethane, and propane. More preferably, the hydrogen-containing reducing stream comprises about 70 mole percent hydrogen, and most preferably at least 80 mole percent hydrogen. The reducing conditions in reducer 16 are sufficient to reduce the valence of the oxidized promoter metal component of the regenerated sorbent particulates. The preferred ranges for such reducing conditions are provided below in Table 6.

TABLE 6
Reducing Conditions

| | Temp | Press. | Superficial Vel. |
|---|---|---|---|
| Range | (° F.) | (psig) | (ft/s) |
| Preferred | 250-1250 | 25-750 | 0.1-4 |
| More Preferred | 600-1000 | 100-400 | 0.2-3 |
| Most Preferred | 750-850 | 150-250 | 0.3-2.5 |

When the regenerated sorbent particulates are contacted with the hydrogen-containing reducing stream in reducer 16 under the reducing conditions described above, at least a portion of the oxidized promoter metal component is reduced to form the reduced-valence promoter metal component of the reduced sorbent particulates. Preferably, at least a substantial portion of the substitutional solid metal oxide solution (M_{X}Zn_{Y}O) is converted to the reduced-valence promoter metal component (M_{A}Zn_{B}).

The reduced sorbent particulates preferably comprise zinc oxide, the reduced-valence promoter metal component (M_{A}Zn_{B}), perlite, and the promoter metal-zinc aluminate substitutional solid (M_{Z}Zn_{(1-Z)}Al₂O₄) in the ranges provided below in Table 7.

TABLE 7
Components of the Reduced Sorbent Particulates

| | | M_{A}Zn_{B} | | M_{Z}Zn_{(1-z)}Al₂O₄ |
|---|---|---|---|---|
| Range | ZnO (wt %) | (wt %) | Perlite (wt %) | (wt %) |
| Preferred | 5-80 | 5-80 | 2-50 | 1-50 |
| More Preferred | 20-60 | 7-60 | 5-30 | 5-30 |
| Most Preferred | 30-50 | 10-40 | 10-20 | 10-20 |

After the sorbent particulates have been reduced in reducer 16, they can be transported back to reactor 12 via a third transport assembly 22 for recontacting with the hydrocarbon-containing fluid stream in reactor 12.

Referring again to FIG. 1, first transport assembly 18 generally comprises a reactor pneumatic lift 24, a reactor receiver 26, and a reactor lockhopper 28 fluidly disposed between reactor 12 and regenerator 14. During operation of desulfurization unit 10 the sulfur-loaded sorbent particulates are continuously withdrawn from reactor 12 and lifted by reactor pneumatic lift 24 from reactor 12 to reactor receiver 18. Reactor receiver 18 is fluidly coupled to reactor 12 via a reactor return line 30. The lift gas used to transport the sulfur-loaded sorbent particulates from reactor 12 to reactor receiver 26 is separated from the sulfur-loaded sorbent particulates in reactor receiver 26 and returned to reactor 12 via reactor return line 30. Reactor lockhopper 26 is operable to transition the sulfur-loaded sorbent particulates from the high pressure hydrocarbon environment of reactor 12 and reactor receiver 26 to the low pressure oxygen environment of regenerator 14. To accomplish this transition, reactor lockhopper 28 periodically receives batches of the sulfur-loaded sorbent particulates from reactor receiver 26, isolates the sulfur-loaded sorbent particulates from reactor receiver 26 and regenerator 14, and changes the pressure and composition of the environment surrounding the sulfur-loaded sorbent particulates from a high pressure hydrocarbon environment to a low pressure inert (e.g., nitrogen) environment. After the environment of the sulfur-loaded sorbent particulates has been transitioned, as described above, the sulfur-loaded sorbent particulates are batch-wise transported from reactor lockhopper 28 to regenerator 14. Because the sulfur-loaded solid particulates are continuously withdrawn from reactor 12 but processed in a batch mode in reactor lockhopper 28, reactor receiver 26 functions as a surge vessel wherein the sulfur-loaded sorbent particulates continuously withdrawn from reactor 12 can be accumulated between transfers of the sulfur-loaded sorbent particulates from reactor receiver 26 to reactor lockhopper 28. Thus, reactor receiver 26 and reactor lockhopper 28 cooperate to transition the flow of the sulfur-loaded sorbent particulates between reactor 12 and regenerator 14 from a continuous mode to a batch mode.

Second transport assembly 20 generally comprises a regenerator pneumatic lift 32, a regenerator receiver 34, and a regenerator lockhopper 36 fluidly disposed between regenerator 14 and reducer 16. During operation of desulfurization unit 10 the regenerated sorbent particulates are continuously withdrawn from regenerator 14 and lifted by regenerator pneumatic lift 32 from regenerator 14 to regenerator receiver 34. Regenerator receiver 34 is fluidly coupled to regenerator 14 via a regenerator return line 38. The lift gas used to transport the regenerated sorbent particulates from regenerator 14 to regenerator receiver 34 is separated from the regenerated sorbent particulates in regenerator receiver 34 and returned to regenerator 14 via regenerator return line 38. Regenerator lockhopper 36 is operable to transition the regenerated sorbent particulates from the low pressure oxygen environment of regenerator 14 and regenerator receiver 34 to the high pressure hydrogen environment of reducer 16. To accomplish this transition, regenerator lockhopper 36 periodically receives batches of the regenerated sorbent particulates from regenerator receiver 34, isolates the regenerated sorbent particulates from regenerator receiver 34 and reducer 16, and changes the pressure and composition of the environment surrounding the regenerated sorbent particulates from a low pressure oxygen environment to a high pressure hydrogen environment. After the environment of the regenerated sorbent particulates has been transitioned, as described above, the regenerated sorbent particulates are batch-wise transported from regenerator lockhopper 36 to reducer 16. Because the regenerated sorbent particulates are continuously withdrawn from regenerator 14 but processed in a batch mode in regenerator lockhopper 36, regenerator receiver 34 functions as a surge vessel wherein the sorbent particulates continuously withdrawn from regenerator 14 can be accumulated between transfers of the regenerated sorbent particulates from regenerator receiver 34 to regenerator lockhopper 36. Thus, regenerator receiver 34 and regenerator lockhopper 36 cooperate to transition the flow of the regenerated sorbent particulates between regenerator 14 and reducer 16 from a continuous mode to a batch mode.

The following examples are presented to further illustrate this invention and are not to be construed as unduly limiting the scope of this invention.

### EXAMPLE I

This example describes the procedure used to prepare two sorbent compositions (Sorbent A and B). The two sorbent compositions employed different commercially available perlite material having unique particle size distributions.

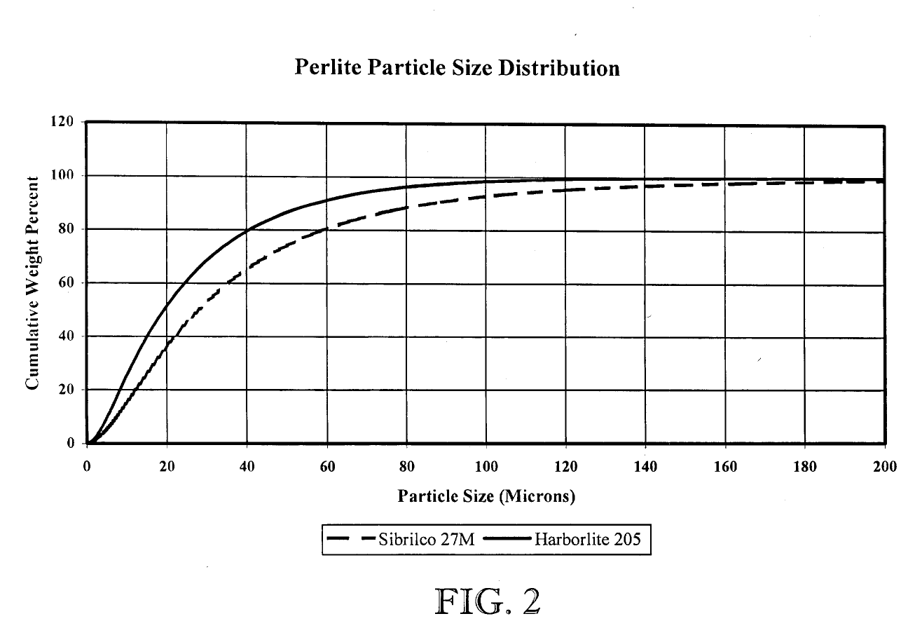

Sorbent A was prepared by mixing 483.0 grams of deionized water and 72.9 grams of aluminum hydroxide powder (Dispal® Alumina Powder, available from CONDEA Vista Company, Houston, Tex.) to create a wet mix. In a separate container, a 287.1 gram quantity of zinc oxide powder (available from Zinc Corporation, Monaca, Pa.) and a 75.0 gram quantity of expanded perlite (Harborlite™ 205 perlite, available from Harborlite Corporation, Antonito, Colo.) were combined to create a dry mix. The Harborlite™ 205 perlite had a particle size distribution that is illustrated in FIG. 2. The Harborlite™ 205 perlite had a mean particle size of about 19.5 microns, and about 95.5 weight percent of the Harborlite™ 205 had a particle size less than 75 microns. Two weight percent of the Harborlite™ 205 had a particle size of about 2.0 microns or less, and two weight percent of the Harborlite™ 205 had a particle size of about 94.0 microns or greater. The wet mix and dry mix were then combined and mixed to form a sorbent base slurry.

The sorbent base slurry was formed into sorbent particulates using a counter-current spray drier (Niro Atomizer Model 68, available from Niro Atomizer, Inc., Columbia, Md.). The sorbent base slurry was charged to the spray drier wherein it was contacted in a particulating chamber with air flowing through the chamber. The resulting spray-dried sorbent base particulates were then sieved to remove particles larger than 100 mesh and smaller than 635 mesh. The sieved sorbent base particulates were then placed in an oven and dried by ramping the oven temperature at 3° C./min to 150° C. and holding at 150° C. for 1 hour. The dried sorbent base particulates were then calcined by ramping the oven temperature at 5° C./min to 635° C. and holding at 635° C. for 1 hour.

A 188.0 gram quantity of the calcined sorbent base particulates were then impregnated with a solution containing 217.5 grams of nickel nitrate hexahydrate and 20.5 grams of distilled water using incipient wetness techniques. The impregnated sorbent was then put in an oven and dried at about 150° C. for about 14 hours. The dried sorbent was then belt calcined at 635° C. for 1.5 hours in three hot zones. The resulting nickel-promoted sorbent comprised 18.0 weight percent nickel and was designated Sorbent A.

Sorbent B was prepared by mixing 918.0 grams of deionized water and 145.7 grams of aluminum hydroxide powder (Dispal® Alumina Powder, available from CONDEA Vista Company, Houston, Tex.) to create a wet mix. In a separate container, a 574.2 gram quantity of zinc oxide powder (available from Zinc Corporation, Monaca, Pa.) and a 150.1 gram quantity of expanded perlite (Sil-Kleer™ 27M, available from Silbrico Corporation, Hodgkins, Ill.) were combined to create a dry mix. The Silbrico™ 27M perlite had a particle size distribution that is illustrated in FIG. 2. The mean particle size of the Silbrico™ 27M was about 28.0 and about 87.0 weight percent of the Silbrico™ 27M had a particle size less than 75 microns. Two weight percent of the Silbrico™ 27M had a particle size of about 2.5 microns or less, and two weight percent of the Silbrico™ 27M had a particle size of about 160 microns or greater. The wet mix and dry mix were then combined and mixed to form a sorbent base slurry.

The sorbent base slurry was formed into sorbent particulates using a counter-current spray drier (Niro Atomizer Model 68, available from Niro Atomizer, Inc., Columbia, Md.). The sorbent base slurry was charged to the spray drier wherein it was contacted in a particulating chamber with air flowing through the chamber. The resulting spray-dried sorbent base particulates were then sieved to remove particles larger than 100 mesh and smaller than 635 mesh. The sieved sorbent base particulates were then placed in an oven and dried at 150° C. for about 16 hours. The dried sorbent base particulates were then belt calcined at 635° C. for 1.5 hours in three hot zones.

A 150.0 gram quantity of the calcined sorbent base particulates were then impregnated with a solution containing 173.5 grams of nickel nitrate hexahydrate and 16.3 grams of distilled water using incipient wetness techniques. The impregnated sorbent was then put in an oven and dried at 150° C. for about 16 hours. The dried sorbent was then belt calcined at 635° C. for 1.5 hours in three hot zones. The resulting nickel-promoted sorbent comprised 18 weight percent nickel and was designated Sorbent B.

### EXAMPLE 2

In this example, the attrition resistance of Sorbents A and B were tested.

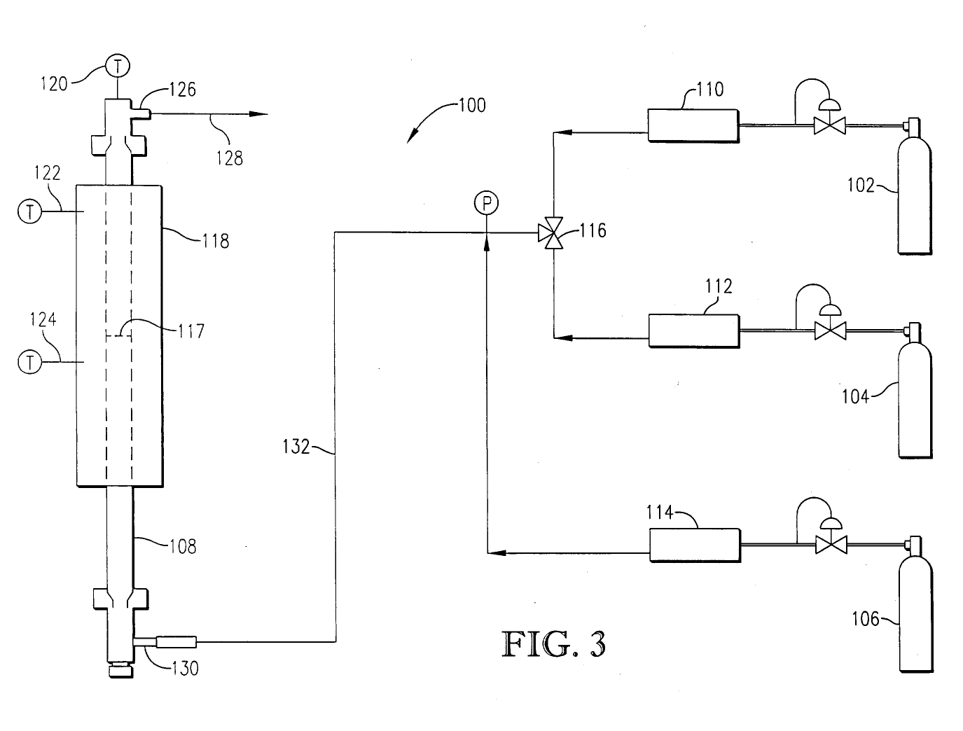

The jet cup attrition index value was determined as disclosed earlier. The Operational Jet Cup Attrition Index value of the sorbent was the Jet Cup Attrition Index of the sorbent, measured after a certain repeated reduction/oxidation (redox) procedure, described in detail below. The repeated redox procedure was designed to simulate the conditions which the sorbent would be exposed to in an actual desulfurization. FIG. 3 shows the redox test system 100 used to “age” Sorbents A and B so that an operational Jet Cup Attrition Index could be measured. Redox test system 100 included a hydrogen source 102, an air source 104, a nitrogen source 106, and a reactor tube 108. Three mass flow controllers 110, 112, 114 controlled the flow rate of hydrogen, air, and nitrogen, respectively, through reactor tube 108. The hydrogen and air passed through a manual three-way valve 116, which prevented both hydrogen and air from flowing to reactor tube 108 at the same time. Reactor tube 108 was a 26-inch quartz reactor tube containing a three-inch upper section with a 0.5-inch outer diameter (O.D.), a 20-inch reactor section (one-inch O.D.) with a glass frit 117 centered in the reactor section, and a three-inch lower section 0.5-inch O.D.). Reactor tube 108 was positioned in a 15-inch long clam shell furnace 118. A thermocouple 120 was disposed at the upper end of reactor tube 108 and extended down into reactor tube 108, three inches above the glass frit 117. Thermocouple 120 was connected to a temperature readout and was not temperature controlling. Two temperature controlling thermocouples 122, 124 were connected through the side of two-zone clam shell furnace 118. A side port 126 at the top of reactor tube 108 was fluidly coupled to a vent line 128. An inlet port 130 of reactor tube 108 is fluidly coupled to hydrogen, air, and nitrogen sources 102, 104, 106 via a supply line 132.

To perform the repeated redox procedure in redox test system 100, the sorbent particulates were first screened to remove particles smaller than 325 mesh and larger than 100 mesh. A 10 gram quantity of the screen sorbent particulates was then loaded on the top of the glass frit 117 through the top of reactor tube 108. Nitrogen was then turned on at 200 standard cubic centimeters per minute (SCCM) and reactor tube 108 was purged with nitrogen for 15 minutes. Reactor tube 108 was then heated to 800° F. in flowing nitrogen for 15 minutes. The nitrogen flow was then stopped and the hydrogen flow rate was set to 300 SCCM. The sorbent was allowed to reduce in flowing hydrogen for one hour. The hydrogen flow was then stopped, and nitrogen was set to flow at 200 SCCM for 15 minutes while reactor tube 108 was heated to 950° F. The nitrogen flow was then stopped and air was turned on to 100 SCCM and the sorbent was allowed to oxidize for one hour. The air was then shut off and nitrogen was allowed to purge reactor tube 108 for 15 minutes at 200 SCCM. The above purge, reduction, purge, oxidation, and purge steps were then repeated two more times for a total of three redox cycles. After the three redox cycles, the nitrogen was stopped and the hydrogen flow rate was set to 300 SCCM and the sorbent was allowed to reduce for one hour. The hydrogen flow was then stopped and nitrogen set to a flow at 200 SCCM for 15 minutes. The nitrogen flow was then stopped and reactor tube 108 was allowed to cool to ambient temperature. The sorbent, having been subjected to 3.5 redox cycles, was then removed from reactor tube 108 and the Jet Cup Attrition Index of this sorbent was determined in the manner described above. The resulting Jet Cup Attrition Index of the “aged” sorbent subjected to 3.5 redox cycles was its Operational Jet Cup Attrition Index.

The “Fresh” and Operational Jet Cup Attrition Index (JCAI) of Sorbents A and B, determined in accordance with the above procedures, are provided below in Table 8.

TABLE 8

| | | | | | Attrition | |
|---|---|---|---|---|---|---|
| | Perlite Type/Properties | | | | Resistance | |
| | | Mean PS | 2% Below | 2% Above | Fresh | Oper. |
| Sorbent | Type | (Microns) | (Microns) | (Microns) | JCAI | JCAI |
| A | Harborlite ™ 205 | 19.5 | 2.0 | 94.0 | 11.5 | 12.3 |
| B | Sibrilco ™ 27M | 28.0 | 2.5 | 160 | 13.8 | 14.6 |

Table 8 shows that the fresh and operational Jet Cup Attrition Index of Sorbent A, employing Harborlite™ 205 perlite, is lower than the Jet Cup Attrition Index of Sorbent B, employing Sibrilco™ 27M perlite. Such enhanced attrition resistance of Sorbent A can be attributed to the smaller and narrower particle size distribution of the Harborlite™ 205 perlite employed in Sorbent A.

Reasonable variations, modifications, and adaptations may be made within the scope of this disclosure and the appended claims without departing from the scope of this invention.

That which is claimed is:

1. A method of making a sorbent composition, said method comprising the steps of:
(a) separating an initial quantity of uncrushed expanded perlite particles into a large particle portion and a small particle portion;
(b) crushing said small particle portion to obtain selectively crushed perlite particles having a mean particle size less than the mean particle size of said small particle portion; and
(c) combining said selectively crushed perlite particles with zinc oxide and a promoter metal to form an unreduced sorbent.

2. The method according to claim 1, wherein step (a) includes sieving said initial quantity of uncrushed expanded perlite particles with a sieve having a screen size in the range of from about 120 to about 350 mesh.

3. The method according to claim 2, wherein said screen size is in the range of from about 180 to about 225 mesh.

4. The method according to claim 1, wherein step (a) includes separating said large particle portion and said small particle portion according to particle size, wherein said large particle portion consists essentially of particles larger than a separation point particle size, wherein said small particle portion consists essentially of particles smaller than said separation point particle size, and wherein said separation point particle size is in the range of from about 25 to about 125 microns.

5. The method according to claim 4, wherein said separation point particle size is in the range of from about 65 to about 85 microns.

6. The method according to claim 4, wherein said separation point particle size is in the range of from 70 to 80 microns.

7. The method according to claim 1, wherein the mean particle size of said selectively crushed perlite particles is less than about 50 percent of the mean particle size of said small particle portion.

8. The method according to claim 7, wherein the mean particle size of said selectively crushed perlite particles is in the range of from about 2 to about 30 microns.

9. The method according to claim 8, wherein said selectively crushed perlite particles comprise less than about 10 weight percent of particles larger than 75 microns and less than about 15 weight percent of particles smaller than 2 microns.

10. The method according to claim 9, wherein said initial quantity of uncrushed perlite particles has a mean particle size in the range of from about 20 to about 60 microns, said small particle portion has a mean particle size in the range of from about 20 to about 50 microns, and said selectively crushed perlite particles have a mean particle size in the range of from about 4 to about 24 microns.

11. The method according to claim 1, further comprising the step of:
(d) reducing said unreduced sorbent with a hydrogen-containing reducing gas.

12. The method according to claim 1, wherein step (c) includes physically mixing said perlite, said zinc oxide, and an aluminum-containing carrier to form a support mixture.

13. The method according to claim 12, wherein step (c) includes shaping said support mixture to form support particulates having a mean particle size in the range of from about 40 to about 150 microns.

14. The method according to claim 13, wherein said shaping is performed by spray drying.

15. The method according to claim 13, wherein step (c) includes impregnating said support particulates with said promoter metal to form a promoted sorbent.

16. The method according to claim 15, wherein step (c) includes calcining said promoted sorbent in an oxygen-containing atmosphere to thereby provide said unreduced sorbent comprising an oxidized promoter metal component.

17. The method according to claim 16, further comprising the step of:
(e) reducing said oxidized promoter metal component to form a reduced sorbent comprising a reduced-valence promoter metal component.

18. A sorbent composition comprising:
perlite;
zinc oxide; and
a reduced-valence promoter metal component,
wherein said perlite has a mean particle size in the range of from about 2 to about 40 microns,
wherein less than about 10 weight percent of said perlite has a particle size greater than 75 microns.

19. The sorbent composition according to claim 18, wherein said perlite has a mean particle size in the range of from about 4 to about 35 microns, wherein less than about 4 weight percent of said perlite has a particle size greater than 75 microns, and wherein less than about 15 weight percent of said perlite has a particle size less than 2 microns.

20. The sorbent composition according to claim 19, wherein said perlite has a mean particle size in the range of from 8 to 30 microns and wherein said sorbent composition has a Davison Index value of less than about 15.

21. The sorbent composition according to claim 18, wherein said sorbent composition comprises said perlite in an amount in the range of from about 2 to about 50 weight percent, said zinc oxide in an amount in the range of from about 5 to about 80 weight percent, and said reduced-valence promoter metal component in an amount in the range of from about 5 to about 80 weight percent.

22. The sorbent composition according to claim 21, wherein said reduced-valence promoter metal component comprises a promoter metal selected from the group consisting of nickel, cobalt, iron, manganese, copper, zinc, molybdenum, tungsten, silver, antimony, and vanadium.

23. The sorbent composition according to claim 22, wherein said reduced-valence promoter metal component comprises a substitutional solid solution characterized by the formula M_{A}Zn_{B}, wherein M is the promoter metal and A and B are each numerical values in the range of from 0.01 to 0.99.

24. The sorbent composition according to claim 23, wherein said promoter metal is nickel, A is in the range of from about 0.70 to about 0.97, and B is in the range of from about 0.03 to about 0.30.

25. The sorbent composition according to claim 22, further comprising an aluminate in an amount in the range of from about 1 to about 50 weight percent.

26. The sorbent composition according to claim 25, wherein said aluminate comprises a promoter metal-zinc aluminate substitutional solid solution characterized by the formula M_{Z}Zn_{(1-Z)}Al₂O₄, wherein M is said promoter metal and Z is a numerical value in the range of from 0.01 to 0.99.

27. A desulfurization process comprising the steps of:
(a) contacting a sulfur-containing fluid with a reduced sorbent in a desulfurization zone under desulfurization conditions sufficient to provide a desulfurized fluid and a sulfur-loaded sorbent, wherein said sorbent comprises perlite, zinc oxide, and a reduced-valence promoter metal component and wherein said perlite has a mean particle size in the range of from about 2 to about 30 microns and wherein less than about 10 weight percent of solid perlite has a particle size greater than 75 microns;
(b) contacting at least a portion of said sulfur-loaded sorbent with an oxygen-containing regeneration stream in a regeneration zone under regeneration conditions sufficient to provide a regenerated sorbent comprising an oxidized promoter metal component;
(c) contacting at least a portion of said regenerated sorbent with a hydrogen-containing reducing stream in a reducing zone under reducing conditions sufficient to reduce at least a portion of said oxidized promoter metal component to said reduced-valence promoter metal component, thereby providing said reduced sorbent; and
(d) recovering a desulfurized fluid.

28. The desulfurization process according to claim 27, wherein step (a) includes converting at least a portion of said zinc oxide to zinc sulfide using sulfur from said sulfur-containing fluid stream.

29. The desulfurization process according to claim 28, wherein step (b) includes converting at least a portion of said zinc sulfide to zinc oxide.

30. The desulfurization process according to claim 27, wherein steps (a), (b), and (c) are simultaneously performed in separate fluidized bed reactors.

31. The desulfurization process according to claim 30, wherein said desulfurization zone is maintained at a desulfurization temperature in the range of from about 250 to about 1,200° F., said regeneration zone is maintained at a regeneration temperature in the range of from about 500 to about 1,500° F., and said reducing zone is maintained at a reducing temperature in the range of from about 250 to 1,250° F.

32. The desulfurization process according to claim 27, wherein said sulfur-containing fluid is selected from the group consisting of gasoline, cracked-gasoline, diesel fuel, and mixtures thereof.

33. The desulfurization process according to claim 27, wherein said oxygen-containing regeneration stream comprises in the range of from about 1 to about 50 mole percent oxygen and wherein said hydrogen-containing reducing stream comprises at least about 50 mole percent hydrogen.

34. The desulfurization process according to claim 27, further comprising the step of:
(d) contacting at least a portion of said reduced sorbent from step (c) with said sulfur-containing fluid in said desulfurization zone under said desulfurization conditions.

35. The desulfurization process according to claim 27, wherein said sorbent is made by the method of claim 1.

36. The desulfurization process according to claim 27, wherein said sorbent is made by the method of claim 17.

37. The desulfurization process according to claim 27, wherein said sorbent is the sorbent composition of claim 24.

38. A sorbent composition made by the method of claim 1.

39. A desulfurized fluid made by the process of claim 27.
